(19) United States
(12) Patent Application Publication
(10) Pub. No.: US 2025/0081885 A1
(43) Pub. Date: Mar. 13, 2025

(54) OUTDOOR POWER MACHINE

(71) Applicant: Greenworks (Jiangsu) Co., Ltd., Changzhou (CN)

(72) Inventors: Qunli Wei, Changzhou (CN); Christopher Eichel, Charlotte, NC (US); Qinghua Shi, Changzhou (CN); Dongdong Shi, Changzhou (CN)

(21) Appl. No.: 18/564,804

(22) PCT Filed: Sep. 6, 2022
(86) PCT No.: PCT/CN2022/117213

§ 371 Date: Nov. 28, 2023

(51) Int. Cl. A01D 34/74; A01D 34/66; A01D 34/78; A01D 101/00

(52) U.S. Cl. CPC A01D 34/74; A01D 34/78; A01D 34/66; A01D 2101/00

(57) ABSTRACT

An outdoor power machine includes a chassis including first and second main frame rails; two or more drive wheel assemblies physically mounted to the chassis, each drive wheel assembly coupled to an electric motor; an electrical power pack configured to supply electric energy to the electric motors; at least one steer wheel pivotally mounted to the chassis; a mowing deck assembly; and a deck lift connecting the mowing deck assembly to the chassis, the deck lift including: a first lift assembly connected to the first main frame rail of the chassis at a first rotation point; a second lift assembly connected to the second main frame rail of the chassis at a second rotation point; wherein the first and second lift assemblies are separated at the first and second rotation points and the first and second rotation points are not interconnected.

### BACKGROUND OF THE INVENTION

This invention relates generally to outdoor power equipment, and more particularly to self-propelled outdoor power machines.

### BACKGROUND

Various types of outdoor power machines are known. Examples of common machines include lawn mowers and lawn tractors. Some outdoor power machines have an operator seat and are considered “ride-on”, “riders”, or “riding” machines. Others accommodate an operator in a standing position, described as a “stand-on” or “stander” machine.

Some known outdoor power machines are battery powered. They include a battery pack which provides electrical power for the primary operating components of the machine, such as the drive wheels and mower deck or other powered implements. The battery pack also provides electrical power for controls, displays, and accessories of the machine.

One problem with prior art outdoor power machines is the center of gravity is too high, creating a risk of tipping or rolling over.

### BRIEF SUMMARY OF THE INVENTION

This problem is addressed by an outdoor power machine which has a deck lifting mechanism that allows a battery pack to be positioned between main frame rails of the machine's chassis, thereby lowering the machine's center of gravity.

According to one aspect of the technology described herein, an outdoor power machine includes a chassis including first and second main frame rails; two or more drive wheel assemblies physically mounted to the chassis, each drive wheel assembly coupled to an electric motor; an electrical power pack configured to supply electric energy to the electric motors; at least one steer wheel pivotally mounted to the chassis; a mowing deck assembly; and a deck lift connecting the mowing deck assembly to the chassis, the deck lift including: a first lift assembly connected to the first main frame rail of the chassis at a first rotation point; a second lift assembly connected to the second main frame rail of the chassis at a second rotation point; wherein the first and second lift assemblies are separated at the first and second rotation points and the first and second rotation points are not interconnected.

According to another aspect of the invention, an outdoor power machine includes a chassis including first and second main frame rails; two or more drive wheel assemblies physically mounted to the chassis, each drive wheel assembly coupled to an electric motor; an electric power pack configured to supply electric energy to the electric motors; at least one steer wheel pivotally mounted to the chassis; a mowing deck assembly; and a deck lift connecting the mowing deck assembly to the chassis, the deck lift including: a first lift assembly having a first end pivotally connected to the first main frame rail of the chassis at a first rotation point; a second lift assembly having a first end pivotally connected to the second main frame rail of the chassis at a second rotation point; a connector extending between a second end of the first lift assembly and a second end of the second lift assembly to interconnect the second end of the first lift assembly and the second end of the second lift assembly; wherein the first and second lift assemblies are separated at the first and second rotation points.

According to another aspect of the invention, an outdoor power machine includes a chassis including first and second main frame rails; two or more drive wheel assemblies physically mounted to the chassis, each drive wheel assembly coupled to an electric motor; an electric power pack configured to supply electric energy to the electric motors; at least one steer wheel pivotally mounted to the chassis; a mowing deck assembly; an electric power pack positioned between the first and second main rails; and a deck lift connecting the mowing deck assembly to the chassis, the deck lift including: a first lift assembly having a first end pivotally connected to the first main frame rail of the chassis at a first rotation point; a second lift assembly having a first end pivotally connected to the second main frame rail of the chassis at a second rotation point; a connector extending between a second end of the first lift assembly and a second end of the second lift assembly to interconnect the second end of the first lift assembly and the second end of the second lift assembly; wherein the first and second lift assemblies are separated at the first and second rotation points.

### BRIEF DESCRIPTION OF THE DRAWINGS

The invention may be best understood by reference to the following description taken in conjunction with the accompanying drawing figures in which:

FIG. 1 is a front perspective view of an exemplary ride-on zero-turn outdoor power machine;

FIG. 2 is a rear perspective view of the machine of FIG. 1;

FIG. 3 is a side elevation view of the machine of FIG. 1;

FIG. 4 is a perspective view of a chassis of the machine of FIG. 1;

FIG. 5 is a front perspective view of an exemplary stand-on zero-turn outdoor power machine;

FIG. 6 is a rear perspective view of the machine of FIG. 5;

FIG. 7 is a side elevation view of the machine of FIG. 5;

FIG. 8 is a perspective view of a chassis of the machine of FIG. 5;

FIG. 9 is a perspective view of an exemplary mowing deck;

FIG. 10 is a bottom plan view of the mowing deck of FIG. 9;

FIG. 11 is a perspective view of the chassis of the machine of FIG. 1 showing a deck lift connected thereto;

FIG. 12 is a perspective view of the deck lift of FIG. 11 connected to a mower deck;

FIG. 13 is a perspective view of the deck lift of FIG. 11 connected to a mower deck;

FIG. 14 is a perspective view of a deck lift of FIGS. 12 and 13;

FIG. 15 is a perspective view of the chassis of the machine of FIG. 5 showing a deck lift connected thereto;

FIG. 16 is a perspective view of the deck lift of FIG. 15; and

FIG. 17 is a perspective view of the deck lift of FIG. 15.

### DETAILED DESCRIPTION OF THE INVENTION

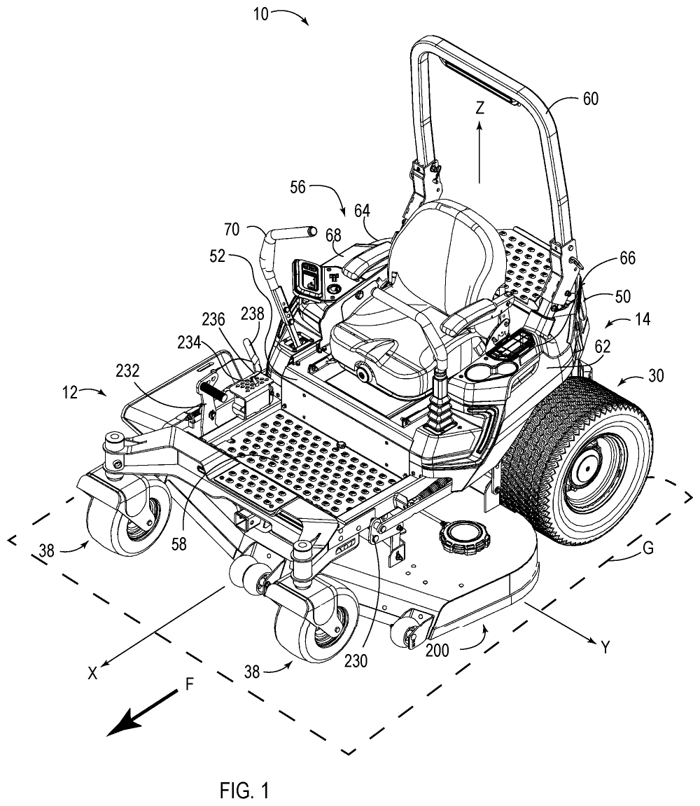

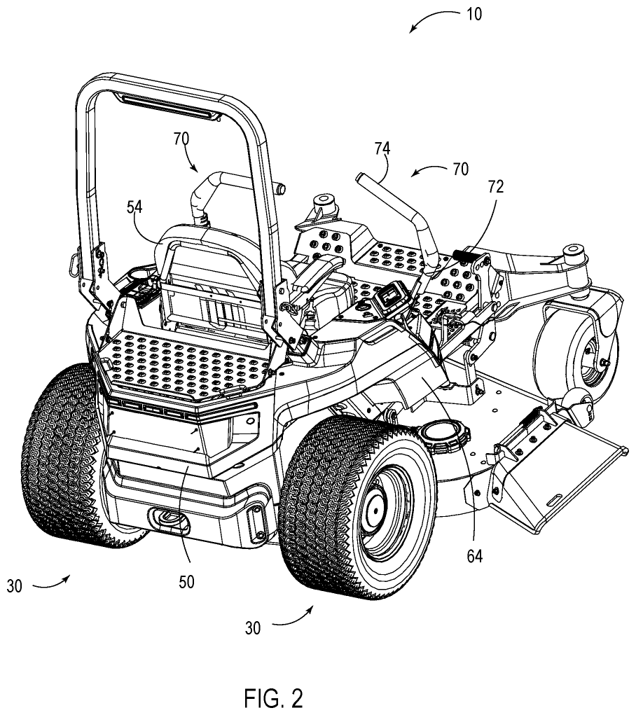

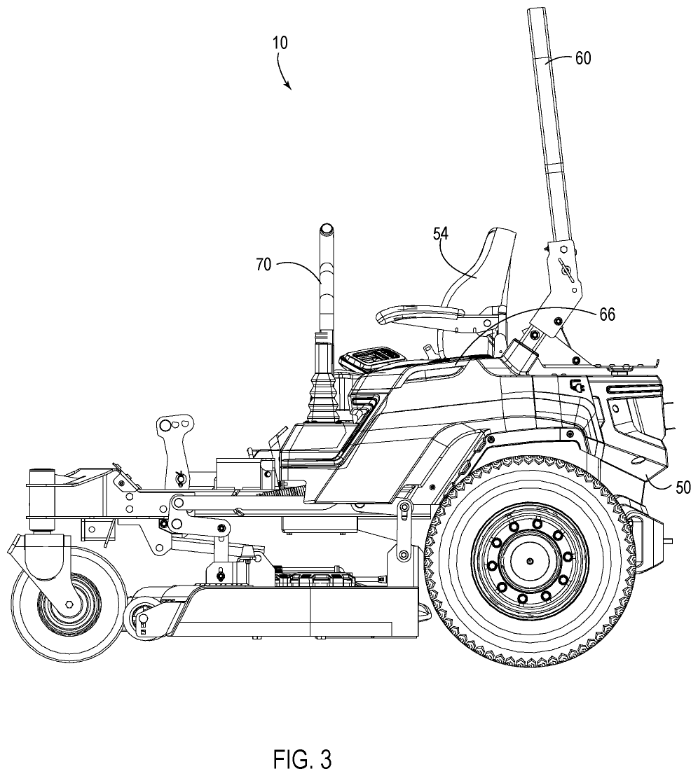

Referring to the drawings wherein identical reference numerals denote the same elements throughout the various views, FIGS. 1-3 show a representative embodiment of an outdoor power machine 10. The machine 10 extends along an axial direction (arrow “X”) between a front end 12 and a rear end 14. The points of contact of the wheels of the machine 10 collectively define a ground plane “G”.

It is noted that, as used herein, the terms “axial” and “longitudinal” both refer to a direction parallel to the axis X, while “vertical” refers to a direction perpendicular to the axial direction and to the ground plane G (see arrow “Z” in FIG. 1) and “lateral” refers to a direction mutually perpendicular to the axial and vertical directions (see arrow “Y” in FIG. 1). A primary forward direction of ground travel is shown by the arrow “F” in FIG. 1. These directional terms are used merely for convenience in description and do not require a particular orientation of the structures described thereby.

In the illustrated example, the outdoor power machine 10 is a zero-turn-radius type machine, alternatively referred to as a “zero-turn” machine. This type of machine is capable of changing its direction of travel (heading) without significant forward or backward movement. This is accomplished by differential rotation of drive wheels on opposite sides of the machine 10 to produce a yawing motion. For example, rotating the right-side wheel forward and simultaneously rotating the left-side wheel backward at the same wheel speed (RPM) will cause the machine 10 to yaw (turn) to the left without moving forwards or backwards. Related steering effects may be obtained by rotating drive wheels on opposite sides in different directions and different wheel speeds, by holding one wheel stationary while driving the opposite-side wheel in a chosen direction, or by rotating the wheels on opposite sides in the same direction at different wheel speeds.

The principles described herein are also applicable to a non zero-turn mower (not shown) using a conventional steering linkage to pivot (steer) some or all of the wheels.

In the example shown in FIGS. 1-3, the machine 10 is a ride-on machine (alternatively referred to as a “rider” or “riding machine”).

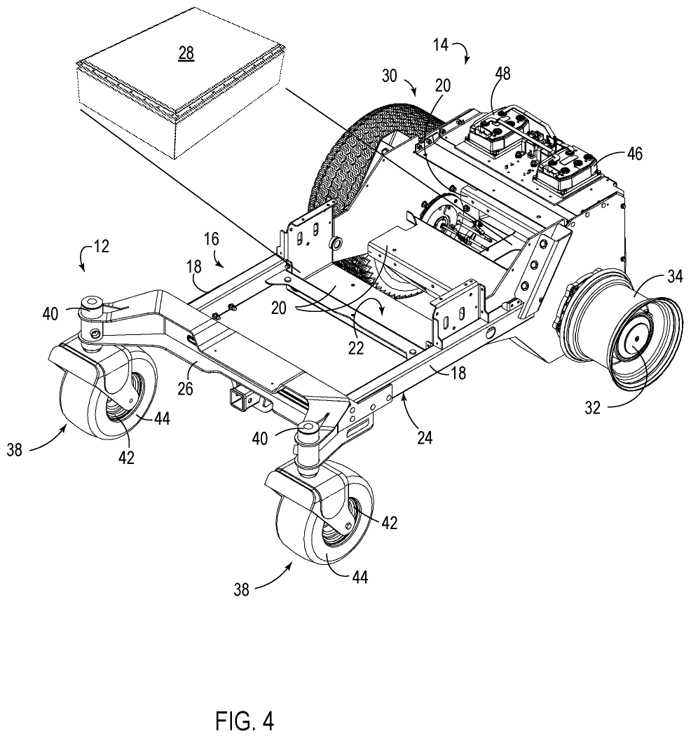

The machine 10 has a chassis 16 (FIG. 4) which provides structural support as well as mounting locations for the various components of the machine 10. Any material with adequate structural strength may be used to construct the chassis 16. Examples of suitable materials include metals such as aluminum and steel and their alloys. The chassis 16 may be monolithic or may be built up from smaller components, e.g., via fasteners, adhesives, or welding.

The chassis 16 includes a pair of spaced-apart main frame rails 18 extending in a longitudinal direction from the front end 12 of the machine 10 to the rear end 14 of the machine 10. Cross-members 20 interconnect the main frame rails 18. Top surfaces 22 of the cross-members 20 are positioned even with or lower than the bottom surfaces 24 of the main frame rails 18.

A front axle assembly 26 interconnects the main frame rails 18 at the front end 12 of the machine 10.

The machine 10 is equipped with an electric power pack 28 suitable for storing and discharging electrical energy. In the illustrated example, the electric power pack 28 is a storage battery including one or more chemical cells, for example lithium ion cells. Other liquid battery chemistries may be substituted, as well as solid state batteries, capacitors, or similar devices which may exist currently or be later developed. The electric power pack 28 may include ancillary electrical components such as inverters, transformers, voltage converters, relays, circuit breakers, and/or sensors. In the illustrated example, the electric power pack 28 includes at least one set of terminals providing a high voltage output (e.g. 82 V) for operating the primary components of the machine 10, such as the drive wheels and mower deck or other powered implement. It also includes another set of terminals providing a low voltage output (e.g. 12 V) for operating the control systems of the machine 10 as well as certain accessories.

The electric power pack 28 is positioned on the cross-members 20 and may be secured by fasteners, clips, latches, or the like (not shown).

The electric power pack 28 is positioned such that some portion of it is located at or below the bottom surfaces 24 of the main frame rails 18. Stated another way, the electric power pack 28 is positioned “between” the main frame rails 18, rather than sitting above or on top of the main frame rails 18.

The machine 10 is equipped with a drive wheel assembly 30, one on each side. Each drive wheel assembly 30 includes an integral drive hub 32 containing an internal electric motor, gear reduction drive, an optional brake (not separately illustrated), a drive wheel 34, and a tire 36 mounted to the drive wheel 34. It is noted that wheels having a ground-engaging surface, and thus not requiring a separate tire, are known in the art. The integral drive hub 32 is physically mounted to the chassis 16 such that the drive wheel 34 can rotate relative to the chassis 16. As will be described in further detail, the machine 10 is configured such that the wheel speed and direction of rotation can be controlled independently for the left and right-side drive wheel assemblies 30. In the illustrated example, the drive wheel assemblies 30 are located at or near the rear end 14 of the machine 10. Alternatively, the drive wheel assemblies 30 could be located at or near the front end 12 of the machine 10.

The machine 10 is equipped with left and right-side steer wheel assemblies 38. Each steer wheel assembly 38 includes a pivot assembly 40, a steer wheel 42, and a tire 44 mounted to the steer wheel 42. It is noted that wheels having a ground-engaging surface, and thus not requiring a separate tire, are known in the art. Each steer wheel assembly 38 is mounted to the chassis 16 such that the steer wheel 42 can rotate relative to the chassis 16 as well as pivot freely about an upright (vertical or near-vertical) axis. The steer wheel assemblies 38 function as casters and therefore passively steer the machine 10. As noted above, the principles described herein are also applicable to a non zero-turn mower (not shown) using a conventional steering linkage to pivot (i.e., actively steer) some or all of the wheels.

The machine 10 is equipped with suitable electrical connections, controls, and switching equipment to permit the operator to control the drive functions of the machine 10. In the illustrated example, the machine 10 includes a left drive motor controller 46 and a right drive motor controller 48. Each of these drive motor controllers 46, 48 includes an electrical power connection to the electric power pack 28 as well as connections to operator controls as described below. Each drive motor controller 46, 48 is operable to receive a command signal from an operator control and to provide electrical power to drive its associated drive wheel assembly 30 at the commanded wheel speed and direction.

The machine 10 includes a body 50 or superstructure positioned above the chassis 16. The body 50 functions to enclose the operating components of the machine 10, to provide the mounting structure for controls and accessories of the machine 10, and to provide a desired external appearance.

The body 50 includes a battery cover assembly 52 which encloses the electric power pack 28.

An operator seat 54 is mounted on top of the battery cover assembly 52. The operator seat 54 may be adjustable in one or more directions, may include retractable armrests, and may include a seatbelt or other restraint for the operator. The battery cover assembly 52 and the operator seat 54 collectively define an “operator station” 56 which functions to support the operator in a position with access to machine controls during operation.

A foot deck 58 is mounted to the chassis 16 forward of the battery cover assembly 52. This serves as a support for the operator's feet. As illustrated, it may be provided with a raised tread structure to increase traction and avoid slippage.

A rollover protection system (“ROPS”) 60 is mounted to the body 50 just aft of the operator seat 54. This is a hoop-like structure or rollbar which extends above the operator's head in the seated position. This functions to prevent injury to the operator should the machine 10 rollover in operation. In the illustrated example, the rollover protection system 60 can be folded down or removed to permit operations under low-hanging structures or vegetation, or to make the machine 10 more compact for transportation.

The body 50 includes left and right fenders 62, 64 respectively which flank the left and right sides of the operator seat 54. The left fender 62 is topped by a left console 66 and the right fender 64 is topped by a right console 68.

The body 50 carries one or more operator controls within reach of the operator seat 54. The primary operator controls include a pair of steering levers 70, one for the left side and one for the right side. Each steering lever 70 is generally L-shaped and includes a vertical section 72 pivotally mounted to the body 50 near the forward edge of the operator seat 54, and a horizontal section 74 which extends from the top of the vertical section 72 towards the centerline X of the machine 10.

Each steering lever 70 is pivotally mounted such that it can move in a fore-aft direction to control drive wheel speed. More specifically, the steering lever 70 is spring-loaded to a neutral position which commands drive wheel speed to stop and/or apply a brake. Movement in the forward direction away from the neutral position commands forward wheel rotation, with RPM proportional to steering lever deflection. Movement in the rearward direction away from the neutral position commands reverse wheel rotation, with RPM proportional to steering lever deflection.

Each steering lever 70 is further pivotally mounted so that it can move in a lateral direction between an outboard parking position and a inboard use position.

Optionally, the machine 10 may be equipped with parking switches (not illustrated) which are operable to detect if the steering levers 70 are in the outboard position or the inboard position. The parking switches may be configured such that the machine drive wheel assemblies 30 cannot be operated unless both steering levers 70 are pivoted to the inboard position.

Further controls are not separately illustrated but can include one or more of the following: a key switch or other security device; a main power switch; an emergency stop control; a blade start/stop switch; a blade speed control; a drive speed limiter or cruise control; and lighting controls. These further controls may be mounted, for example to the left or right consoles 68, 70.

The outdoor power machine 10 may be used as follows. First, the operator sits in the operator seat 54 and activates the key switch or main power switch. A blade start/stop switch or other switch is used to turn on mowing blades or other powered implement, and the implement is adjusted to an operating position, such as a desired cutting height for mowing. The steering levers 70 are moved from the outboard parking position to the inboard use position. The operator then uses the steering levers 70 to drive the outdoor power machine 10 in the desired direction while mowing or other implement operation takes place. It will be understood from the above description that manipulation of the steering levers 70 is sufficient to control forward and aft movement of the outdoor power machine 10, as well as braking and steering.

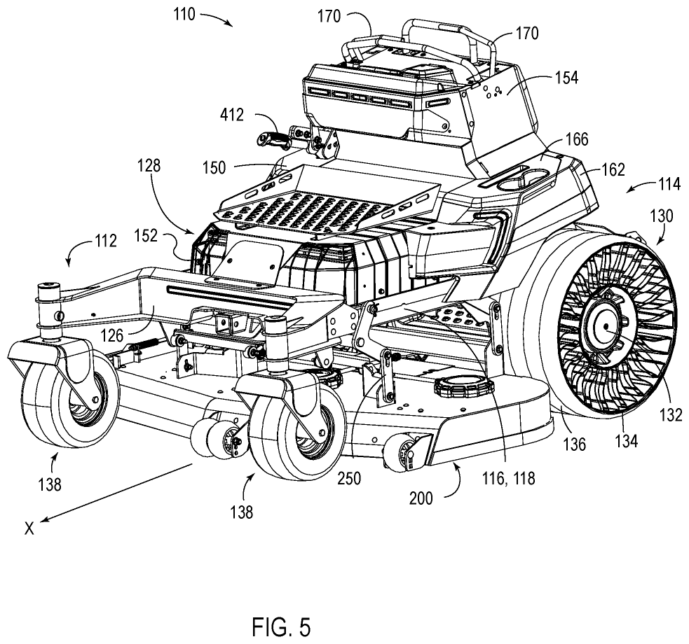

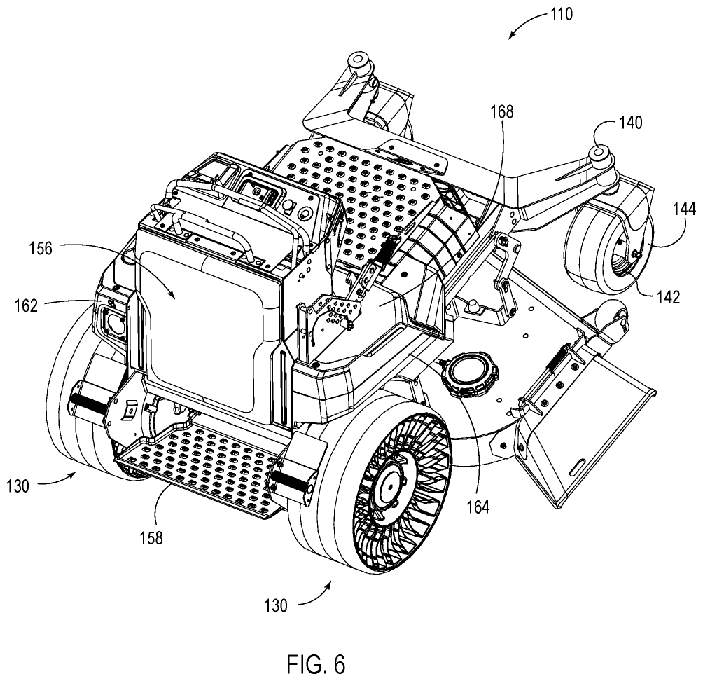

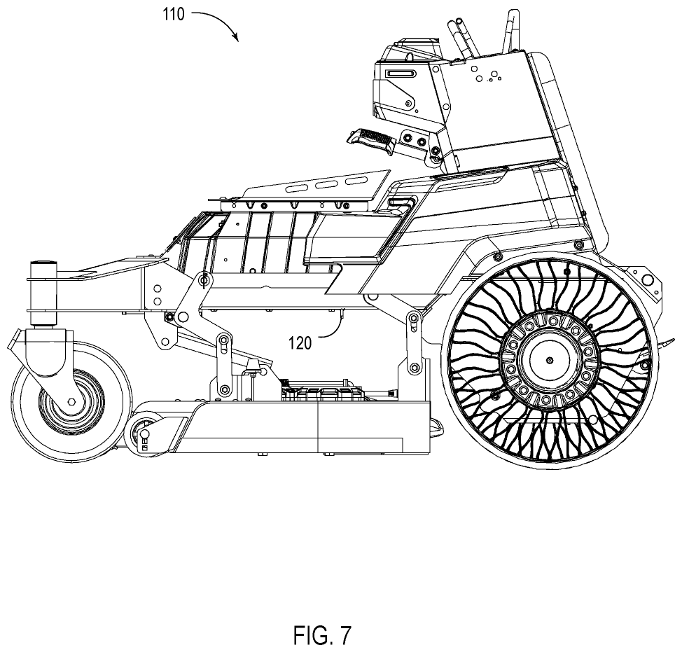

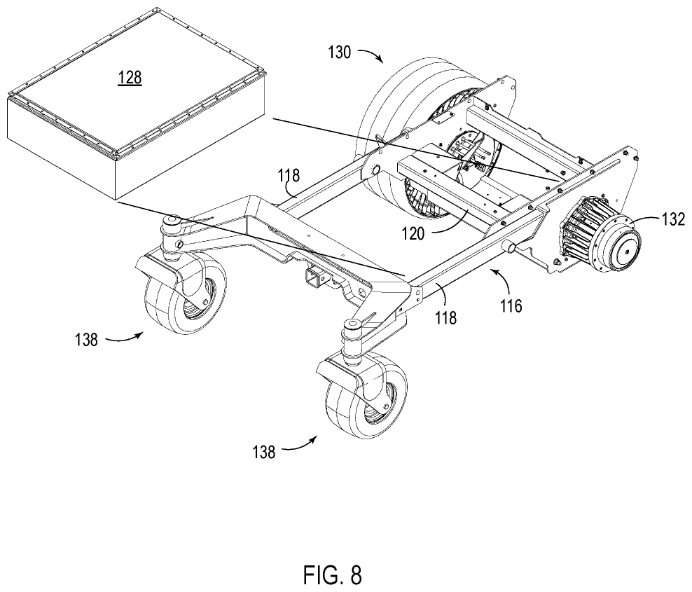

FIGS. 5-8 illustrate another exemplary embodiment of an outdoor power machine 110. This embodiment of the machine 110 is a stand-on machine (alternatively referred to as a “stander”). The overall construction of the machine 110 is similar to the machine described above. Elements of the machine 110 not explicitly described may be taken to be identical to the machine 110 described above.

The machine 110 has a chassis 116 including main frame rails 118 extending in a longitudinal direction from a front end 112 of the machine 110 to a rear end 114 of the machine 110. Cross-members 120 interconnect the main frame rails 118. A front axle assembly 126 interconnects the main frame rails 118 at the front end 112 of the machine 110.

The machine 110 is equipped with an electric power pack 128 as described above.

The machine is equipped with left and right-side drive wheel assemblies 130. Each drive wheel assembly 130 includes an integral drive hub 132 containing an electric motor, a gear reduction drive, and an optional brake (not separately illustrated), a drive wheel 134, and a tire 136 mounted to the drive wheel 134. It is noted that wheels having a ground-engaging surface, and thus not requiring a separate tire, are known in the art. In the illustrated example, the drive wheel assemblies 130 are located at or near the rear end 114 of the machine 110. Alternatively, the drive wheel assemblies 130 could be located at or near the front end 112 of the machine 110.

The machine 110 is equipped with left and right-side steer wheel assemblies 138. Each steer wheel assembly 138 includes a pivot assembly 140, a steer wheel 142, and a tire 144 mounted to the steer wheel 142. It is noted that wheels having a ground-engaging surface, and thus not requiring a separate tire, are known in the art. Each steer wheel assembly 138 is mounted to the chassis 116 such that the steer wheel 142 can rotate relative to the chassis 116 as well as pivot freely about an upright (vertical or near-vertical) axis. The steer wheel assemblies 138 function as casters and therefore passively steer the machine 110. As noted above, the principles described herein are also applicable to a non zero-turn mower (not shown) using a conventional steering linkage to pivot (i.e., actively steer) some or all of the wheels.

The machine 110 is equipped with suitable electrical connections, controls, and switching equipment to permit the operator to control the drive functions of the machine 110. The machine 110 includes a left drive motor controller and a right drive motor controller (not visible in the figures) Each of these drive motor controllers includes a electrical power connection to the electrical power pack 128 as well as connections to operator controls as described below. Each drive motor controller is operable to receive a command signal from an operator control and to provide electrical power to drive its associated drive wheel assembly 130 at the commanded wheel speed and direction.

The machine 110 includes a body 150 or superstructure positioned above the chassis 116.

The body 150 includes a battery cover assembly 152 which encloses the electric power pack 128. A control pedestal 154 is mounted on top of the battery cover assembly 152.

A foot deck 158 is mounted to the chassis 116 aft of the battery cover assembly 152. This serves as a support for the operator's feet. As illustrated, it may be provided with a raised tread structure to increase traction and avoid slippage. The battery cover assembly 152, the control pedestal 154, and the foot deck 158 collectively define an “operator station” 156 which functions to support the operator to provide access to machine controls during operation.

The body 150 includes left and right fenders 162, 164 respectively which flank the left and right sides of the control pedestal 154. The left fender 162 is topped by a left console 166 and the right fender 164 is topped by a right console 168.

The body 150 carries one or more operator controls within reach of the operator station 156. The primary operator controls include a pair of steering levers 170, one for the left side and one for the right side. Each steering lever 170 is generally L-shaped and includes a vertical section 172 pivotally mounted to the control pedestal 154, and a horizontal section 174 which extends from the top of the vertical section 172 towards the centerline X of the machine 110. Each steering lever 170 is pivotally mounted such that it can move in a fore-aft direction to control drive wheel speed as described above.

Each steering lever 170 is further pivotally mounted so that it can move in a laterhual direction between an outboard parking position and a inboard use position. Optionally, the machine 110 may be equipped with parking switches as described above.

Further controls are not separately illustrated but can include one or more of the following: a key switch or other security device; a main power switch; an emergency stop control; a blade start/stop switch; a blade speed control; a drive speed limiter or cruise control; and lighting controls. These further controls may be mounted, for example to the control pedestal 154 or to the left or right consoles 166, 168.

Any of the outdoor power machines described herein may be equipped with one or more implements, defined generally as a device attached to or carried by the machine and operable to cut, shape, load, lift, move, or transport material. Nonlimiting examples of implements include mowing decks, plows, disks, scarifiers, rippers, aerators, dethatchers, blades, buckets, scrapers, or blowers.

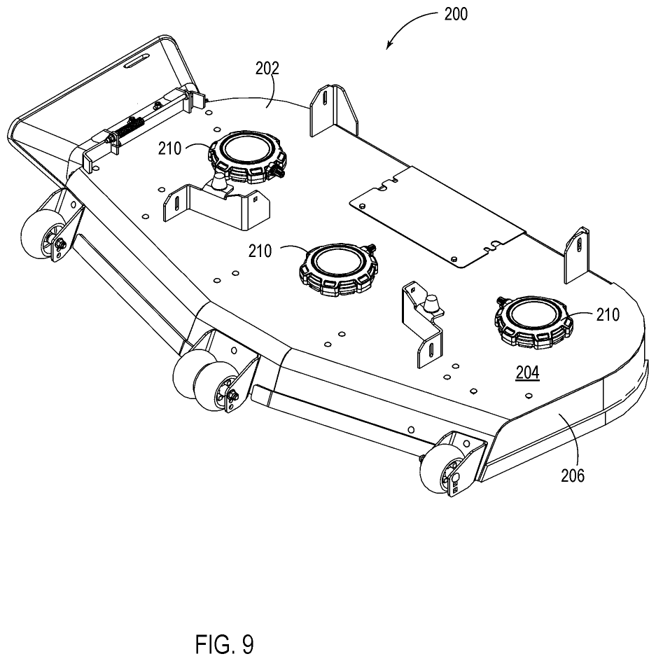

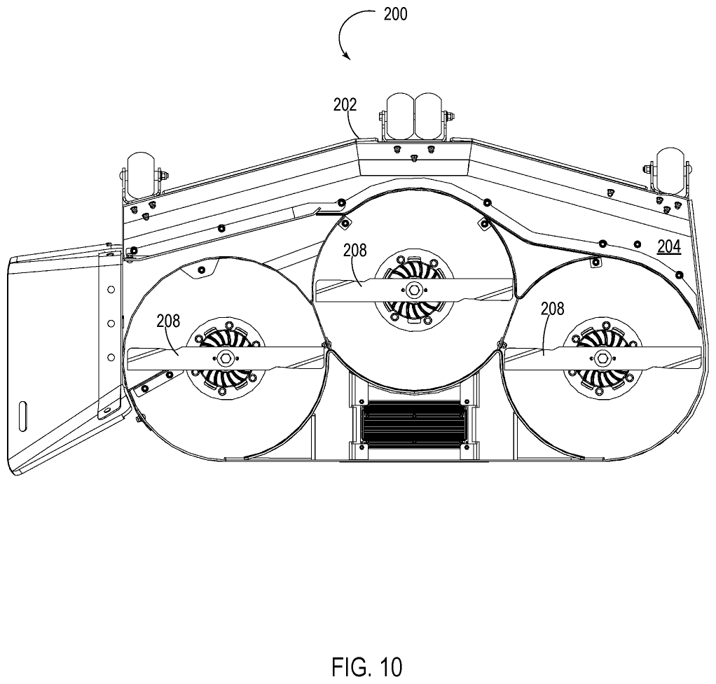

In the illustrated example, the machine 10 or 110 is equipped with a mowing deck assembly 200 (FIGS. 9, 10). It includes a deck 202 which is an open-bottomed enclosure including a top panel 204 and a peripheral wall 206.

The deck 202 has a nominal designated width which may be selected to provide a desired cutting swath. Non-limiting examples of suitable deck widths include 48 inches, 52 inches, 60 inches, or 72 inches.

One or more mowing blades 208 are rotatably mounted on the underside of the top panel 204. The mowing blades 208 are positioned in a side-by side configuration such that their tips will not collide in operation. The mowing blades 208 may be positioned to have some overlap in at least one dimension so as to prevent un-mowed strips during mower operation. The dimensions of the individual mowing blades 208 are selected to provide adequate structural strength at selected operating speed, (e.g. 3600 RPM). Generally, the size of the individual mowing blades 208 is equal to the deck width divided by the number of mowing blades 208, with some additional diameter provided to accommodate for swath overlap. For example, a deck 202 having a nominal width of 60 inches may use three mowing blades 208 each having a diameter of 20.5 inches.

Means are provided for driving the mowing blades 208. Nonlimiting examples of suitable drive methods include mechanical, hydraulic, or electrical devices. In the illustrated example, each mowing blade 208 is directly driven by its own individual electric blade motor 210.

The mowing deck assembly 200 is connected to the chassis via a deck lift 230. The deck lift 230 is operable to position the mowing blades 208 at a preselected distance above the ground plane G of the machine. Typical examples include a cutting height in the range of approximately 1 inch to approximately 6 inches. The deck lift 230 is also operable to lift the mowing deck assembly 200 well above any intended cutting height so that the machine can traverse obstacles, travel along a road to a worksite, or be loaded or unloaded from a trailer or storage building. This is referred to as a “travel position”.

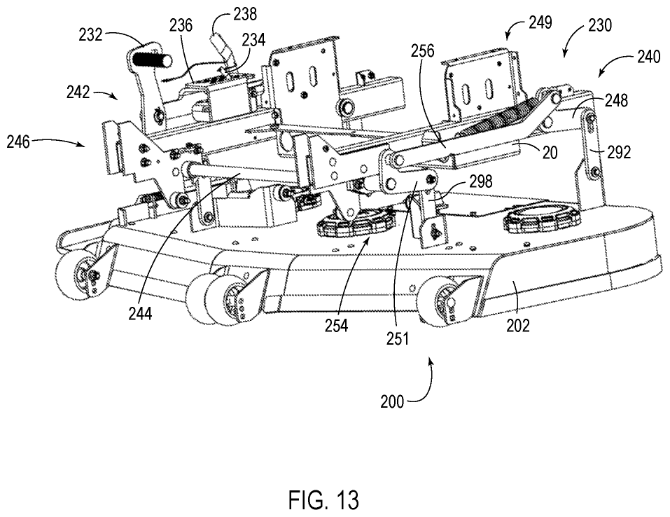

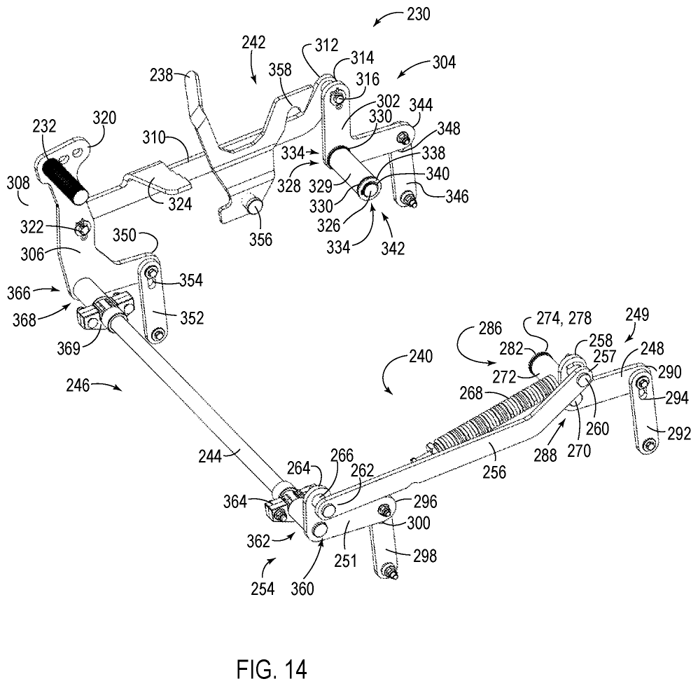

In the example shown in FIGS. 1-4 and 11-14, the deck lift 230 includes a foot pedal 232 to raise the deck lift 230. A removable pin 234 is insertable into a selected hole in a blade height adjuster 236. The position of the pin 234 determines a cutting height by blocking the deck lift 230 at a specific position. An uplock lever 238 is provided to selectively lock and release the deck lift 230 in the travel position.

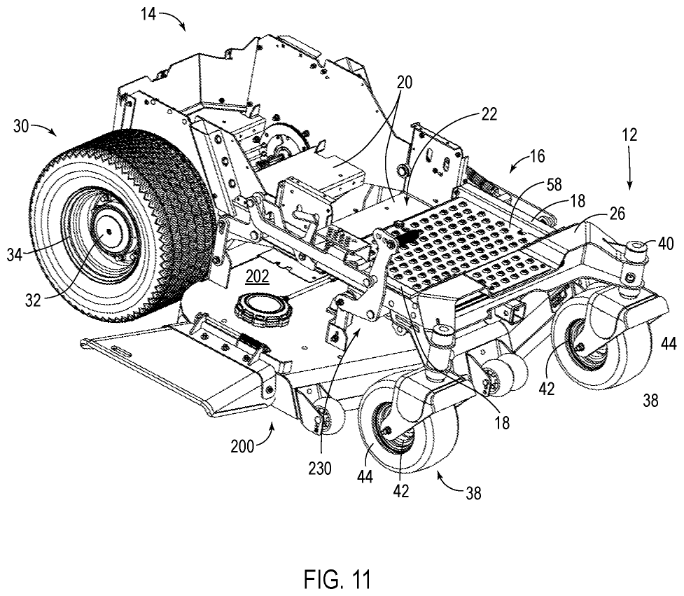

Referring more specifically to FIGS. 11-14, the deck lift 230 includes a first lift assembly 240, a second lift assembly 242, and a tie rod 244 interconnecting the first and second lift assemblies 240, 242 at a front 246 thereof. As shown, the first lift assembly 240 is located on the left side of the machine 10 and the second lift assembly 242 is located on the right side of the machine 10; however, it should be appreciated that the lift assemblies may be reversed with the first lift assembly 240 located on the right side and the second lift assembly 242 located on the left side.

The first lift assembly 240 includes a first bell crank 248 positioned at a rear 249 of the first lift assembly 240, a second bell crank 251 positioned at a front 254 of the first lift assembly 240, and a central arm 256 extending between the first and second bell cranks 248, 251. The central arm 256 having a first end 257 pivotally connected to a first end 258 of the first bell crank 248 by a first pivot pin 260 and an opposing second end 262 pivotally connected to a first end 264 of the second bell crank 251 by a second pivot pin 266.

A spring 268 is connected between first pivot pin 260 and frame rail 18. The spring 268 helps a user lift the deck 202 by reducing the amount of force needed to lift the deck 202 by about 50 to 80 percent and more particularly by about 55 to 65 percent.

The first bell crank includes a pin 270 extending through a rotation point 288 of the first bell crank 248 for connecting the first bell crank 248 to frame rail 18. The pin 270 extends through a housing 272 in frame rail 18. Bushings and/or sleeve bearings 274 are inserted into opposing ends 278 of the housing 272 and may be made of a material such as oil embedded metals, sintered bronze, bronze, graphite and various polymers. The bushings 274 center the pin 270 in the housing 272 and allow the pin 270 to rotate within the housing 272. The pin 270 extends through the bushings 274 to allow for rotation within the housing 272 and is secured in the housing 272 by washer 282 and retaining clip 284 (same as retaining clip 340 shown on second lift assembly 242). Together, the pin 270, housing 272, bushings 274, and first bell crank 248 form a first rotation point 286 of the deck lift 230.

A second end 290 of the first bell crank 248 is pivotally connected to the deck 202 by a first deck linkage 292. The first deck linkage 292 having a slot 294 to allow for leveling and/or adjustment of the deck 202. Likewise, a second end 296 of the second bell crank 251 is pivotally connected to the deck 202 by a second deck linkage 298. The second deck linkage 298 also including a slot 300 for leveling and/or adjustment of the deck 202.

The second lift assembly 242 includes a third bell crank 302 positioned at a rear 304 of the second lift assembly 242, a fourth bell crank 306 positioned at a front 308 of the second lift assembly 242, and a central arm 310 extending between the third and fourth bell cranks 302, 306. The central arm 310 having a first end 312 pivotally connected to a first end 314 of the third bell crank 302 by third pivot pin 316 and an opposing second end 318 pivotally connected to the fourth bell crank 306 near a first end 320 thereof by a fourth pivot pin 322. As illustrated, the fourth bell crank 306 operates as a foot lever to raise and lower the deck 202 using the foot pedal 232 connected to the first end 320. The first end 320 including adjustment holes to allow a user to move the foot pedal 232 to a desired use position.

The central arm 310 further includes a blade member 324. The blade member 324 is positioned forward of a center of the central arm 310 and interacts with the pin 234 of the blade height adjuster 236 to maintain the deck 202 at a mowing height.

The third bell crank 302 includes a pin 326 extending through a rotation point 328 of the third bell crank 302 for connecting the third bell crank 302 to frame rail 18. The pin 326 extends through a housing 329 in frame rail 18. Bushings and/or sleeve bearings 330 are inserted into opposing ends 334 of the housing 329 and may be made of a material such as oil embedded metals, sintered bronze, bronze, graphite and various polymers. The bushings 330 center the pin 326 in the housing 329 and allow the pin 326 to rotate within the housing 329. The pin 326 extends through the bushings 330 to allow for rotation within the housing 329 and is secured in the housing 329 by washer 338 and retaining clip 340. Together, the pin 326, housing 329, bushings 330, and third bell crank 302 form a second rotation point 342 of the deck lift 230.

A second end 344 of the third bell crank 302 is pivotally connected to the deck 202 by a third deck linkage 346. The third deck linkage 346 having a slot 348 to allow for leveling and/or adjustment of the deck 202. Likewise, a second end 350 of the fourth bell crank 306 is pivotally connected to the deck 202 by a fourth deck linkage 352. The fourth deck linkage 352 also including a slot 354 for leveling and/or adjustment of the deck 202.

Uplock lever 238 is pivotally connected to frame rail 18 by pin 356 and moveable between a locked and unlocked position. The uplock lever 238 includes a hook 358 which engages third pivot pin 316 when the deck is raised to lock and maintain the deck 202 in the travel position when the uplock lever 238 is moved to the locked position. The hook 358 is disengaged to lower the deck 202 by pressing the foot pedal 232 and moving the uplock lever 238 to the unlocked position.

As discussed above, the tie rod 244 interconnects the first and second lift assemblies 240, 242. A first end 360 of the tie rod is pivotally connected to a rotation point 362 of the second bell crank 251 and is secured to frame rail 18 by a pillow block 364. A second end 366 of the tie rod is pivotally connected to a rotation point 368 of the fourth bell crank 306 and is secured to frame rail 18 by pillow block 369.

As can be seen, the front 254 of the first lift assembly 240 and the front 308 of the second lift assembly 242 are interconnected by the tie rod 244 and secured to frame rails 18. The rear 249 of the first lift assembly 240 and the rear 304 of the second lift assembly are not connected; rather, rotation points 286 and 342 are directly connected to frame rails 18 and do not extend through a center of the chassis 16, leaving an open space therebetween.

The combination of the deck lift rotation points 286, 342 not extending through the center of the chassis 16 and the drive wheel assemblies 30 being mounted completely outside of the main chassis 16 allows the power pack 28 to be positioned between frame rails 18 as opposed to being positioned on top of the frame rails 18; thus, lowering the center of gravity (COG) of the machine 10 and helping to prevent rollover accidents.

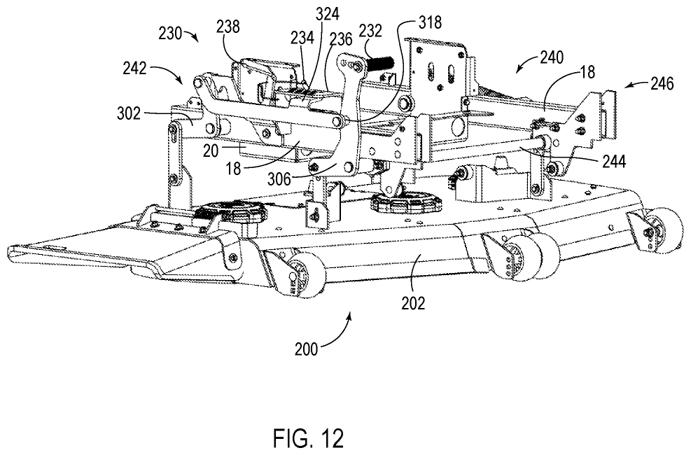

As illustrated in FIG. 12, cross-member 20 is positioned below the bottom surfaces 24 of the main frame rails 18, permitting a portion of the electric power pack 28 to be positioned on the cross-member 20 at a location below the bottom surfaces 24 of the main frame rails 18.

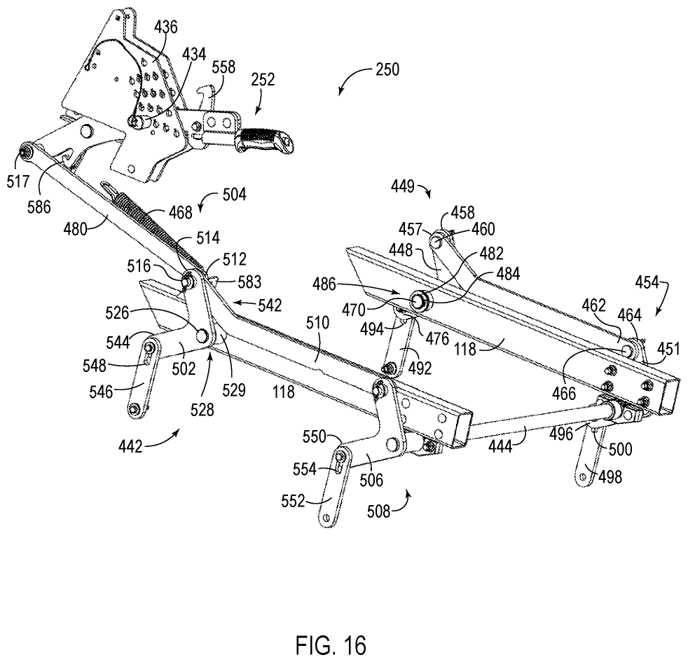

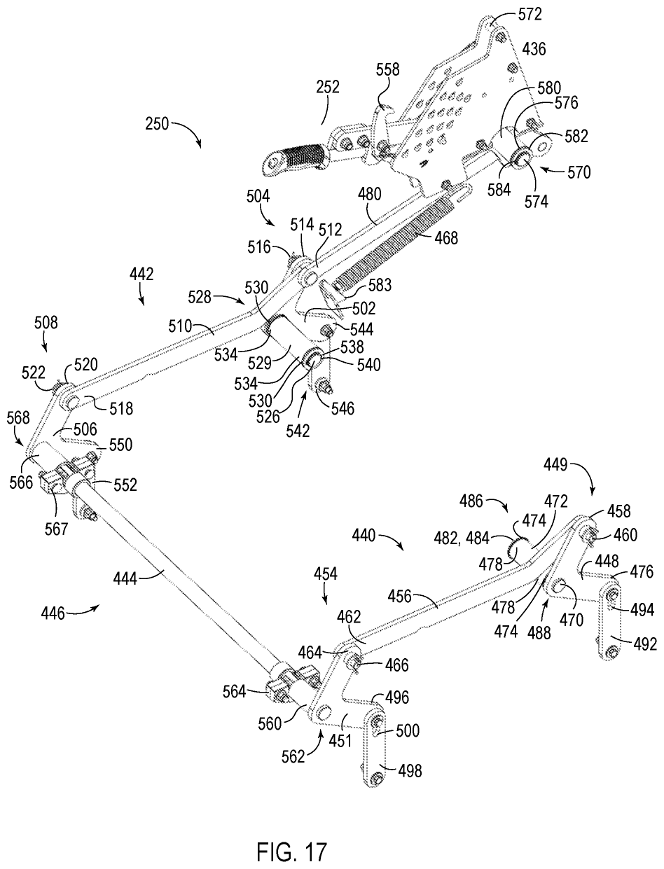

In the example shown in FIGS. 5-8 and 15-17, the mowing deck assembly 200 is connected to the chassis 116 via a deck lift 250. The deck lift 250 is similar to the deck lift 230 described above, the primary difference being that it is operated by a hand lever 252 as opposed to a pedal. Elements of the deck lift 250 not explicitly described may be taken to be identical to the deck lift 230 described above.

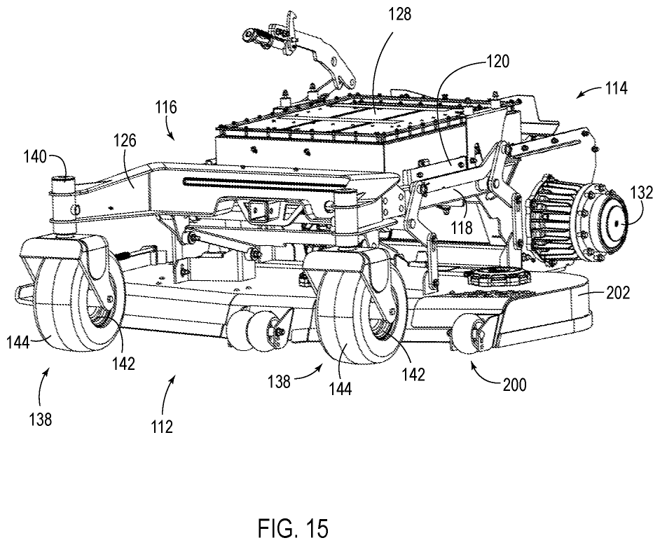

As shown in FIG. 15, the electric power pack 128 sits between frame rails 118 with a portion of the electric power pack 128 sitting below or flush with a bottom surface 124 of the frame rails 118.

The deck lift 250 includes a first lift assembly 440, a second lift assembly 442, and a tie rod 444 interconnecting the first and second lift assemblies 440, 442 at a front 446 thereof. As shown, the first lift assembly 440 is located on the left side of the machine 110 and the second lift assembly 442 is located on the right side of the machine 110; however, it should be appreciated that the lift assemblies may be reversed with the first lift assembly 440 located on the right side and the second lift assembly 442 located on the left side.

The first lift assembly 440 includes a first bell crank 448 positioned at a rear 449 of the first lift assembly 440, a second bell crank 451 positioned at a front 454 of the first lift assembly 440, and a central arm 456 extending between the first and second bell cranks 448, 451. The central arm 456 having a first end 457 pivotally connected to a first end 458 of the first bell crank 448 by a first pivot pin 460 and an opposing second end 462 pivotally connected to a first end 464 of the second bell crank 451 by a second pivot pin 466.

The first bell crank 448 includes a pin 470 extending through a rotation point 488 of the first bell crank 448 for connecting the first bell crank 448 to frame rail 118. The pin 470 extends through a housing 472 in frame rail 118. Bushings and/or sleeve bearings 474 are inserted into opposing ends 478 of the housing 472 and may be made of a material such as oil embedded metals, sintered bronze, bronze, graphite and various polymers. The bushings 474 center the pin 470 in the housing 472 and allow the pin 470 to rotate within the housing 472. The pin 470 extends through the bushings 474 to allow for rotation within the housing 472 and is secured in the housing 472 by washer 482 and retaining clip 484. Together, the pin 470, housing 472, bushings 474, and first bell crank 448 form a first rotation point 486 of the deck lift 250.

A second end 476 of the first bell crank 448 is pivotally connected to the deck 202 by a first deck linkage 492. The first deck linkage 492 having a slot 494 to allow for leveling and/or adjustment of the deck 202. Likewise, a second end 496 of the second bell crank 451 is pivotally connected to the deck 202 by a second deck linkage 498. The second deck linkage 498 also including a slot 500 for leveling and/or adjustment of the deck 202.

The second lift assembly 442 includes a third bell crank 502 positioned at a rear 504 of the second lift assembly 442, a fourth bell crank 506 positioned at a front 508 of the second lift assembly 442, and a central arm 510 interconnecting the third and fourth bell cranks 502, 506. The central arm 510 having a first end 512 pivotally connected to a first end 514 of the third bell crank 502 by third pivot pin 516 and opposing second end 518 pivotally connected to the fourth bell crank 506 at a first end 520 by a fourth pivot pin 522. A hand lever extension member 480 is pivotally connected between hand lever 252 and first ends 512 and 514 by pivot pins 516 and 517 to allow the hand lever 252 to operate the deck lift 250.

The third bell crank 502 includes a pin 526 extending through a rotation point 528 of the third bell crank 502 for connecting the third bell crank 502 to frame rail 118. The pin 526 extends through a housing 529 in frame rail 118. Bushings and/or sleeve bearings 530 are inserted into opposing ends 534 of the housing 529 and may be made of a material such as oil embedded metals, sintered bronze, bronze, graphite and various polymers. The bushings 530 center the pin 526 in the housing 529 and allow the pin 526 to rotate within the housing 529. The pin 526 extends through the bushings 530 to allow for rotation within the housing 529 and is secured in the housing 529 by washer 538 and retaining clip 540. Together, the pin 526, housing 529, bushings 530, and third bell crank 502 form a second rotation point 542 of the deck lift 250.

A second end 544 of the third bell crank 502 is pivotally connected to the deck 202 by a third deck linkage 546. The third deck linkage 546 having a slot 548 to allow for leveling and/or adjustment of the deck 202. Likewise, a second end 550 of the fourth bell crank 506 is pivotally connected to the deck 202 by a fourth deck linkage 552. The fourth deck linkage 552 also including a slot 554 for leveling and/or adjustment of the deck 202.

The hand lever 252 is pivotally connected to chassis 116 by third rotation point 570 and moveable between a locked and unlocked position. Third rotation point 570 is the same as first rotation point 486 and second rotation point 542 and includes pin 574, bushings 576, housing 580, washer 582, and retaining clip 584.

The hand lever 252 interacts with the pin 434 of blade height adjuster 436 to maintain the deck 202 at a mowing height when the hand lever is moved to an unlocked position. The hand lever 252 includes a hook 558 which engages pin 572 of the blade height adjuster 436 when the deck 202 is raised to lock and maintain the deck 202 in a travel position when the hand lever 252 is moved to the locked position.

A spring 468 is connected between chassis member 583 and hook and/or spring retaining member 586 of the hand lever 252. The spring 468 helps a user lift the deck 202 by reducing the amount of force needed to lift the deck 202 by about 50 to 80 percent and more particularly by about 55 to 65 percent. As the hand lever 252 is pulled back, the spring retracts to help lift the deck 202.

As discussed above, the tie rod 444 interconnects the first and second lift assemblies 440, 442. A first end 560 of the tie rod is pivotally connected to a rotation point 562 of the second bell crank 451 and is secured to frame rail 118 by a pillow block 564. A second end 566 of the tie rod is pivotally connected to a rotation point 568 of the fourth bell crank 506 and is secured to frame rail 118 by pillow block 567.

As can be seen, the front 454 of the first lift assembly 440 and the front 508 of the second lift assembly 442 are interconnected by the tie rod 444 and secured to frame rails 118. The rear 449 of the first lift assembly 440 and the rear 504 of the second lift assembly are not connected; rather, rotation points 486 and 542 are directly connected to frame rails 118 and do not extend through a center of the chassis 116, leaving an open space therebetween.

The combination of the deck lift rotation points 486, 542 not extending through the center of the chassis 116 and the drive wheel assemblies 130 being mounted completely outside of the main chassis 116 allows the power pack 128 to be positioned between frame rails 118 as opposed to being positioned on top of the frame rails 118; thus, lowering the center of gravity (COG) of the machine 110 and helping to prevent rollover accidents.

The machine described herein has advantages over prior art machines by providing a deck lift and drive motors that do not intersect a center and/or middle portion of the machine between the main frame rails. This arrangement allows an electric power pack to be positioned lower in the chassis between the main frame rails; thus, lowering the COG and reducing rollovers.

The foregoing has described an outdoor power machine. All of the features disclosed in this specification, and/or all of the steps of any method or process so disclosed, may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends, or to any novel one, or any novel combination, of the steps of any method or process so disclosed.

What is claimed is:

1. An outdoor power machine, comprising:
a chassis including first and second main frame rails;
two or more drive wheel assemblies physically mounted to the chassis, each drive wheel assembly coupled to an electric motor;
an electrical power pack configured to supply electric energy to the electric motors;
at least one steer wheel pivotally mounted to the chassis;
a mowing deck assembly; and
a deck lift connecting the mowing deck assembly to the chassis, the deck lift including:
a first lift assembly connected to the first main frame rail of the chassis at a first rotation point;
a second lift assembly connected to the second main frame rail of the chassis at a second rotation point;
wherein the first and second lift assemblies are separated at the first and second rotation points and the first and second rotation points are not interconnected.

2. The outdoor power machine of claim 1, wherein the electric power pack is positioned between the first and second main rails.

3. The outdoor power machine of claim 2, wherein a portion of the electric power pack is positioned below a lower surface of the first and second main rails.

4. The outdoor power machine of claim 2, wherein a portion of the electric power pack is positioned flush with a lower surface of the first and second main rails.

5. The outdoor power machine of claim 1, wherein a first end of the first lift assembly is connected to the first main rail of the chassis at the first rotation point and the first end of the second lift assembly is connected to the second main rail of the chassis at the second rotation point.

6. The outdoor power machine of claim 1, wherein a second end of the first lift assembly is connected to a second end of the second lift assembly by a connector extending therebetween.

7. An outdoor power machine, comprising:
a chassis including first and second main frame rails;
two or more drive wheel assemblies physically mounted to the chassis, each drive wheel assembly coupled to an electric motor;
an electric power pack configured to supply electric energy to the electric motors;
at least one steer wheel pivotally mounted to the chassis;
a mowing deck assembly; and
a deck lift connecting the mowing deck assembly to the chassis, the deck lift including:
a first lift assembly having a first end pivotally connected to the first main frame rail of the chassis at a first rotation point;
a second lift assembly having a first end pivotally connected to the second main frame rail of the chassis at a second rotation point;
a connector extending between a second end of the first lift assembly and a second end of the second lift assembly to interconnect the second end of the first lift assembly and the second end of the second lift assembly;
wherein the first and second lift assemblies are separated at the first and second rotation points.

8. The outdoor power machine of claim 7, wherein the electric power pack is positioned between the first and second main rails.

9. The outdoor power machine of claim 8, wherein a portion of the electric power pack is positioned below a lower surface of the first and second main rails.

10. The outdoor power machine of claim 8, wherein a portion of the electric power pack is positioned flush with a lower surface of the first and second main rails.

11. The outdoor power machine of claim 7, wherein the first lift assembly includes:
a first bell crank at the first end of the first lift assembly;
a second bell crank at the second end of the first lift assembly; and
a central arm extending between and pivotally connecting the first and second bell cranks.

12. The outdoor power machine of claim 11, wherein the first bell crank connects the first lift assembly to the first main rail and the second bell crank is connected to a first end of the connector.

13. The outdoor power machine of claim 7, wherein the second lift assembly includes:
a third bell crank at the first end of the second lift assembly;
a fourth bell crank at the second end of the second lift assembly; and
a central arm extending between and pivotally connecting the third and fourth bell cranks.

14. The outdoor power machine of claim 13, wherein the third bell crank connects the second lift assembly to the second main rail and the fourth bell crank is connected to a second end of the connector.

15. The outdoor power machine of claim 13, further including a hand lever pivotally connected to the chassis and configured to lift the mowing deck assembly, the hand lever being connected to the third bell crank by a hand lever extension member.

16. An outdoor power machine, comprising:
a chassis including first and second main frame rails;
two or more drive wheel assemblies physically mounted to the chassis, each drive wheel assembly coupled to an electric motor;
an electric power pack configured to supply electric energy to the electric motors;
at least one steer wheel pivotally mounted to the chassis;
a mowing deck assembly;
an electric power pack positioned between the first and second main rails; and
a deck lift connecting the mowing deck assembly to the chassis, the deck lift including:
a first lift assembly having a first end pivotally connected to the first main frame rail of the chassis at a first rotation point;
a second lift assembly having a first end pivotally connected to the second main frame rail of the chassis at a second rotation point;
a connector extending between a second end of the first lift assembly and a second end of the second lift assembly to interconnect the second end of the first lift assembly and the second end of the second lift assembly;
wherein the first and second lift assemblies are separated at the first and second rotation points.

17. The outdoor power machine of claim 16, wherein the electric power pack is positioned between the first and second rotation points.

18. The outdoor power machine of claim 16, further including a spring configured to assist in the lifting of the mowing deck assembly.

19. The outdoor power machine of claim 16, further including a foot pedal connected to the deck lift to lift the mowing deck assembly.

20. The outdoor power machine of claim 16, further including a hand lever connected to the deck lift to lift the mowing deck assembly.
